(19) United States
(12) Patent Application Publication
(10) Pub. No.: US 2026/0120169 A1
(43) Pub. Date: Apr. 30, 2026

(54) TRAINING ARTIFICIAL INTELLIGENCE MODEL USING TAGS FOR SEQUENCES OF UNITS TO RECOMMEND FUTURE UNITS

(71) Applicant: Hungryroot, Inc., New York, NY (US)

(72) Inventors: Antoine Atallah, Bellevue, WA (US); Xiaowei Bao, Portland, OR (US); Jasmine Feng, Renton, WA (US); Jingchen Cao, Dublin, CA (US); Benjamin Pierce McKean, Mooresville, NC (US)

(21) Appl. No.: 18/931,825

(22) Filed: Oct. 30, 2024

(51) Int. Cl. G06Q 30/0601; G06Q 30/0282

(52) U.S. Cl. CPC G06Q 30/0633; G06Q 30/0282

(57) ABSTRACT

Systems and methods to predict and select groups of units for users. An artificial intelligence mechanism is used to generate a model to predict a next group of units for a target user based on a plurality of sequence of tags for a plurality of sequences of groups of units. A corresponding sequence of tags is generated for each corresponding sequence of groups of units based on start and end tags for each group in each corresponding sequence of groups of units, start and end tags of each unit in each corresponding sequence of groups of units, and tags for each unit in each corresponding sequence of groups of units. The generated model is employed to predict multiple groups of units for a target user based on a sequence of tags for a sequence of groups of units previously provided to the target user.

### TECHNICAL FIELD

The present disclosure relates generally to unit selection and distribution systems and, more particularly, to training and utilizing artificial intelligence mechanisms to dynamically predict units for users.

### BACKGROUND

### Description of the Related Art

The use of ordering food and grocery, and other products, online has gained in popularity over the past few years. Many of these online services allow users to select which items they wish to purchase using an online computer interface. After the user selects and pays for their items, a “runner” collects the items from the shelves such that the user can simply pick up their order and take it home. Some systems also allow for the items to be sent directly to the user's home. These systems, however, generally require the user to know which items they wish to purchase. Some newer systems have added the option of a user selecting groups of items, such as a particular recipe. The specific items and their portions for that particular group are then sent to the user. Upon arrival, the user can prepare the unit, e.g., recipe, using the items provided. Unfortunately, many of these online item-purchasing systems are limited by the user's preferences and provide little flexibility in understanding how different user may prefer different groups of items. It is with respect to these and other considerations that the embodiments described herein have been made.

### BRIEF SUMMARY

Briefly described, embodiments are directed toward systems and methods of selecting groups of units for users. An artificial intelligence mechanism is used to generate a model to predict a next group of units for a target user based on a plurality of sequence of tags for a plurality of sequences of groups of units. The plurality of sequences of groups of units are first received for a plurality of users. Each corresponding sequence of groups of units of the plurality of sequences of groups of units is then processed to generate the corresponding sequence of tag. Tags are generated for a start and an end of each group in the corresponding sequence of groups of units. Similarly, tags are generated for a start and an end of each unit in the corresponding sequence of groups of units. Tags are also obtained for each unit in the corresponding sequence of groups of units. Finally, the corresponding sequence of the tags is generated for the corresponding sequence of groups of units based on these tags.

After the model is generated, an order for a group of units is received for a target user. A sequence of groups of units previously provided to the target user is determined and converted into a sequence of tags. The generated model is then employed to predict multiple groups of units for the user based on the sequence of tags for the sequence of groups of units previously provided to the target user. A group of units can then be selected for the order from the predicted multiple groups of units, and filling of the order is initiated with items associated with the selected group of units for the target user.

Embodiments described herein can improve the operation of the item delivery computing systems, reduce errors in item deliveries, improve user or customer satisfaction, reduce the amount of item waste in users' homes and at the fulfillment warehouse, and even improve the operation of the various computing components of the system. For example, by specifically training an artificial intelligence model using sequences of tags, as described herein, fewer computing resources are then utilized to predict a next group of units to provide to a target user because the system does not have to waste computing resources generating and comparing scores for multiple units and multiple different combinations of unit groups in an attempt to select a highest scoring group of units. Moreover, the automatic fulfillment of an order with one of the predicted groups of units includes the command or control of other computing systems, which again improves the operation of item delivery computing systems.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 illustrates a context diagram of an environment for training and employing of an artificial intelligence model using tags for sequences of units to recommend future units to initiate filling of orders for users in accordance with embodiments described herein;

FIGS. 2A-2B illustrate use case examples of generating a sequence of tags for a sequence of units in accordance with embodiments described herein;

FIG. 3 illustrates a logical flow diagram showing one embodiment of a process for employing of an artificial intelligence model using tags for sequences of units to predict a group of units for a target user and to initiate the filling of an order for the predicted group of units in accordance with embodiments described herein;

FIG. 4 illustrates a logical flow diagram showing one embodiment of a process for training an artificial intelligence model using tags for sequences of units to predict a next group of units for a target user in accordance with embodiments described herein;

FIG. 5 illustrates a logical flow diagram showing one embodiment of a process for generating a sequence of tags for a sequence of groups of units in accordance with embodiments described herein;

FIG. 6 illustrates a use case example of data structure mapping units and tags in accordance with embodiments described herein; and

FIG. 7 shows a system diagram that describes various implementations of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

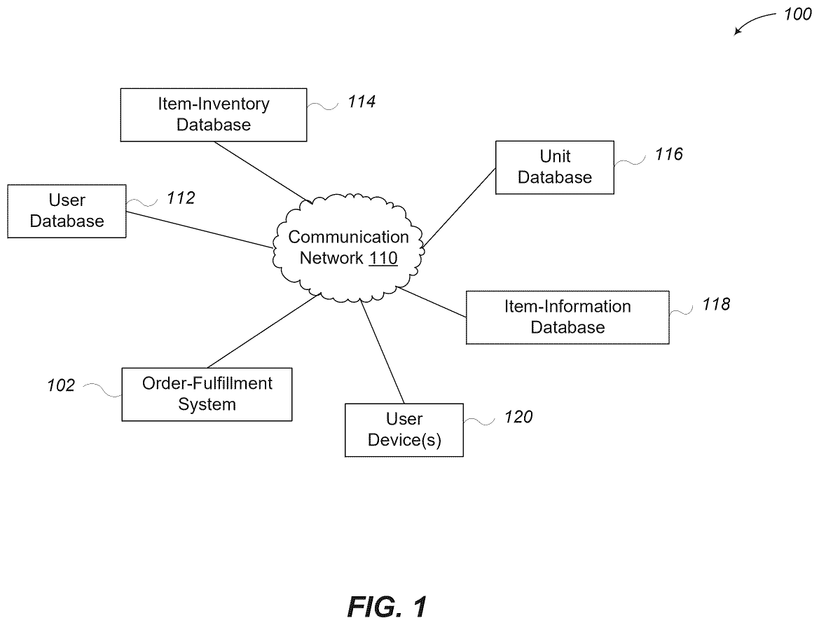

FIG. 1 illustrates a context diagram of an environment for training and employing of an artificial intelligence model using tags for sequences of units to recommend future units to initiate filling of orders for users in accordance with embodiments described herein;

FIG. 1 illustrates a context diagram of an environment 100 for selecting, predicting, and providing groups of units to users in accordance with embodiments described herein. In this example, environment 100 includes an order-fulfillment system 102, a user database 112, an item-inventory database 114, a unit database 116, an item-information database 118, and a user devices 120. These computing devices and systems can communicate with one another via communication network 110. Communication network 110 includes one or more wired or wireless networks in which data or communication messages are transmitted between various computing devices.

The order-fulfillment system 102 is a computing device or system that generates an artificial intelligence model from a plurality of sequences of tags for a group of units, which can be employed to predict a next group of units for a target user. As described herein, users may receive groups of units at a maximum frequency, such as once per week, once every other week, etc. A group of units may include one or more units, such as recipes, outfits, health care packages, or other goods or products that can be sent or delivered to users. Moreover, each unit may include one or more items. Items are objects provided with the units for the users to implement the unit. In the example where a group of units include recipes, items may include the various ingredients, food products, cooking utensils, measurement tools, or other non-food objects needed to make the recipes. In the example where units include outfits, the items may include clothes, shoes, jewelry, bags, or other wearable accessories that make up an outfit.

In some situations, a group of units may not be provided to users at the maximum frequency. For example, some users may be provided a group of units every other week, while other users may be provided a group of units every week, and yet other users may randomly select weeks in which to not receive a group of units. The weeks, or intervals within the maximum frequency, where a user is not provided a group of units may be referred to as a no-unit groups.

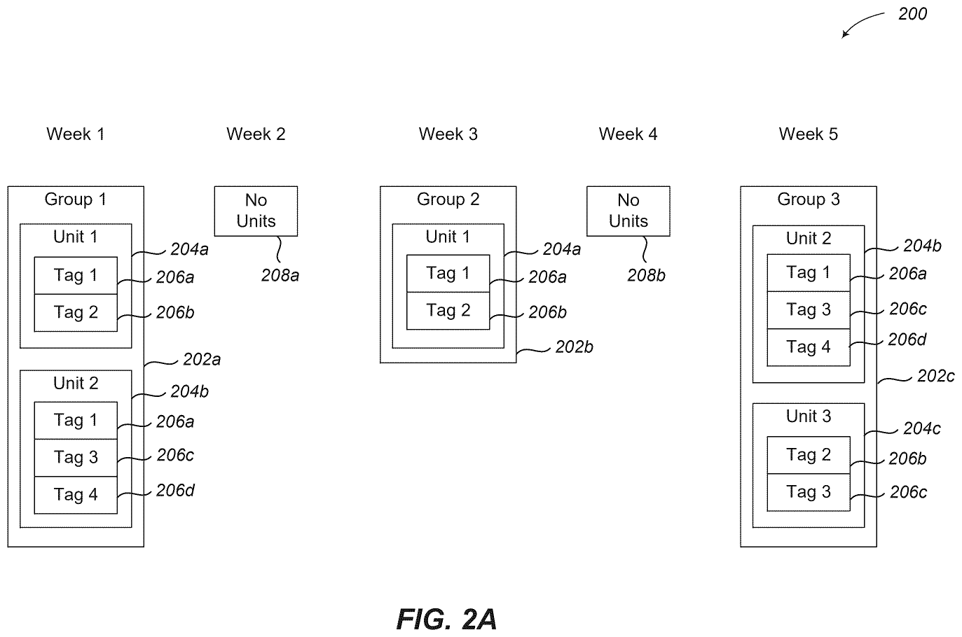

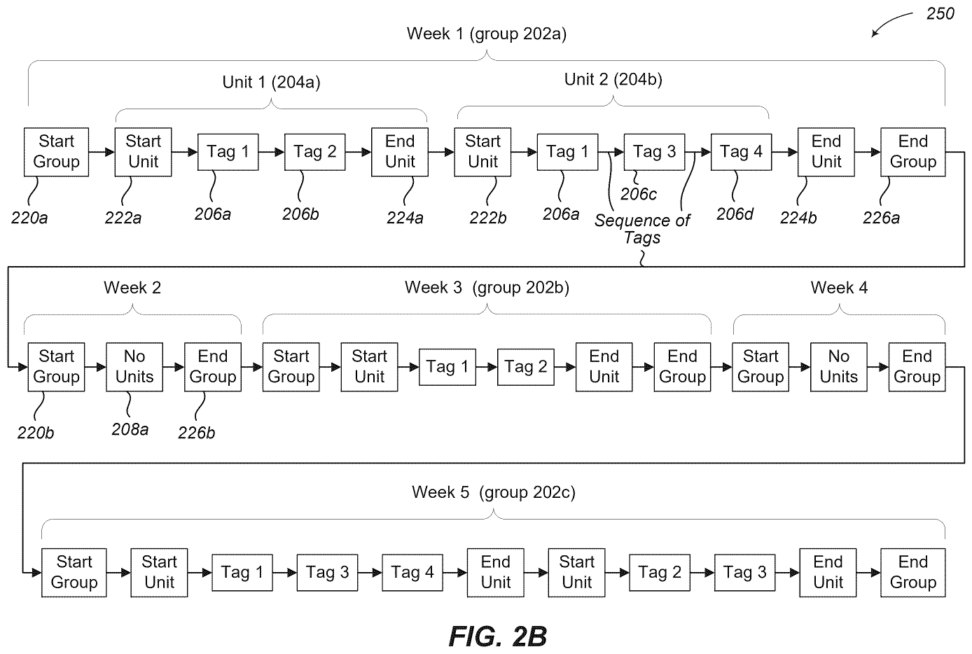

To train or generate the model, the order-fulfillment system 102 generates a plurality of sequences of tags for a plurality of sequences of groups of units that were provide to a plurality of users. The tags not only indicate attributes or the units or items associated with a unit, but the tags also indicate the start and stop of each unit, along with and the start and stop of each group of units. Even no-unit groups are assigned tagged within the sequence of tags. An illustrative example of a sequence of tags is shown in FIGS. 2A-2B. These sequences of tags are then used as the training data within an artificial intelligence mechanism to train the model.

Once trained, the order-fulfillment system 102 can use the model predict a next group of units for an order for a target user. The order may be received by a user device 120 or automatically initiated in accordance with the maximum frequency. A sequence of groups of units previously provided to the target user is identified and converted into a sequence of tags. This sequence of groups of units may include all groups of units, and no-unit groups, provided to the target user at the maximum frequency for a select amount of time (e.g., the groups of units provided to the user each week for the past year). The sequence of tags for sequence of groups of units previously provided to the target user are input into the model, which outputs a plurality of predicted next groups of units. The order-fulfillment system 102 can then select a particular group of units from the predicted next groups of units and initiate the fulfillment of the order for the target user with the units and items associated with the selected group of units

The user devices 120 are computing devices that can communicate with the order-fulfillment system 102 to request orders of groups of units, select units or items, provide user/customer preferences, etc. Examples of user devices 120 may include personal computers, laptop computers, smartphones, tablet computers, etc.

The user database 112 is a computing device that is configured to store user/customer information for a plurality of users. The customer information may include, but is not limited to, user preferences, histories of groups of units previously provided to users (i.e., user order history), user customization history, lists of items previously provided to the user, current user inventory (e.g., items or ingredients already owned by the user), etc. The user database 112 is further configured to communicate with the order-fulfillment system 102 via the communication network 110 to provide various user/customer information to the order-fulfillment system 102 to enable the order-fulfillment system 102 to generate or employ an artificial intelligence model based on sequences of groups of units, as described herein.

The unit database 116 is a computing device that is configured to store a plurality of units. The unit database 116 is configured to communicate with the order-fulfillment system 102 via the communication network 110 to provide lists of units and their items to the order-fulfillment system 102 for the order-fulfillment system 102 to predict, optimize, and select groups of units for users, as described herein.

The item-inventory database 114 is a computing device configured to store inventory information regarding a plurality of items that are associated with at least one unit stored by the unit database 116 and can be delivered to a user. The item-inventory database 114 is further configured to communicate with the order-fulfillment system 102 via the communication network 110 to provide item-inventory information to the order-fulfillment system 102 for the order-fulfillment system 102 to predict, optimize, and select groups of units for users, as described herein.

The item-information database 118 is a computing device that is configured to store information regarding the plurality of items that are associated with at least one unit stored by the unit database 116. In the example where units include recipes, this item information may include, but is not limited to, dietary information, specific ingredients, cost or price, volume metrics, etc. In the example where units include outfits, this item information may include, sizes, colors, seasons, etc. The item-information database 118 is further configured to communicate with the order-fulfillment system 102 via the communication network 110 to provide item information to the order-fulfillment system 102 for the order-fulfillment system 102 to optimize or select groups of units for users, as described herein.

Although the order-fulfillment system 102, the user database 112, the item-inventory database 114, the unit database 116, and the item-information database 118 are illustrated as separate computing devices or systems, embodiments are not so limited. Rather one or more computing devices or systems may be utilized to perform the functionality of the order-fulfillment system 102, the user database 112, the item-inventory database 114, the unit database 116, and the item-information database 118. Accordingly, in some embodiments, the order-fulfillment system 102 may store or manage the user database 112, the item-inventory database 114, the unit database 116, or the item-information database 118, or some combination thereof. Similarly, the functionality of the order fulfillment system 102 may be employed by a single computing system or a plurality of computing systems. For example, a first computing system may employ embodiments described herein to generate the artificial intelligence model to predict a next group of units from a plurality of sequences of groups of units, and a second computing system may employ embodiments described herein to utilize the generated model to predict a next group of units for a target user.

FIGS. 2A-2B illustrate use case examples of generating a sequence of tags for a sequence of units in accordance with embodiments described herein. FIG. 2A illustrates a sequence of groups of units 200 provided to a user. Sequence 200 includes a maximum frequency of one week, i.e., the user can receive groups of units once a week at maximum, but otherwise could receive groups of units less frequently. In this example, the user is provided with groups of units 202a, 202b, and 202c on weeks 1, 3, and 5, respectively.

Group 202a in week 1 includes unit 204a and unit 204b, group 202b in week 3 also includes unit 204a, and group 202c in week 5 includes unit 204b and 204c. In this example, unit 204a includes tags 206a and 206b; unit 204b includes tags 206a, 206c, and 206d; and unit 204c includes tags 206b and 206c. As described herein, each tag represents an attribute, characteristic, of information regarding the respective unit. On the weeks where the user did not receive a group of units, a no-unit group is identified. In this example, a no-unit group 208a is identified in week 2 and a no-unit group 208b is identified in week 4.

FIG. 2B illustrates a sequence of tags 250 for the sequence of groups of units 200 illustrated in FIG. 2A. As described herein, start tags and end tags are generated for each group and each unit, and each no-unit group, which allows for the artificial intelligence mechanism to learn the difference between units and groups of units.

As noted above, group 202a in week 1 includes unit 204a and unit 204b, where unit 204a includes tags 206a and 206b and unit 204b includes tags 206a, 206c, and 206d. A start-group tag 220a is generated for group 202a and added to the sequence of tags 250. A start-unit tag 222a is then generated for unit 204a and added to the sequence of tags 250. Tags 206a and 206b for unit 204a are then obtained and added to the sequence of tags 250. An end-unit tag 224a is then generated for unit 204a and added to the sequence of tags 250. Similarly, a start-unit tag 222b is then generated for unit 204b and added to the sequence of tags 250. Tags 206a, 206c, and 206d for unit 204b are then obtained and added to the sequence of tags 250. An end-unit tag 224b is then generated for unit 204a and added to the sequence of tags 250. Finally, an end-group tag 226a is then generated for group 202a and added to the sequence of tags 250. This illustrated sequence of tags is for the groups of units provided to the user in week 1 of the sequence of groups of units.

For week 2, no groups of units were provided to the user. Accordingly, a start-group tag 220b is generated and added to the sequence of tags 250. A no-unit group tag 208a is then generated and added to the sequence of tags 250. Finally, an end-group tag 226b is generated and added to the sequence of tags 250.

Tags are similarly generated and added to the sequence of tags 250 for weeks 3, 4, and 5. As illustrated, tags are positioned in order sequentially within the sequence of tags in the same order in which the groups of units are provided to the user. But the order in which items within a group are tagged may be different from what is shown. For example, in this illustration, tags associated with unit 204a are ordered before tags associated with unit 204b. But other situations tags associated with unit 204b could be ordered before tags associated with unit 204a. Similarly, the order of tags 206a and 206b for unit 204a could be in a different order from what is shown.

The sequence of tags 250 is for illustration purposes and could include other numbers of groups of units, other numbers of units, and other numbers of item tags. Moreover, the sequence of tags 250 may be generated for training an artificial intelligence model, or it may be used as input into a trained model to predict a next group of units for a target user, as described herein.

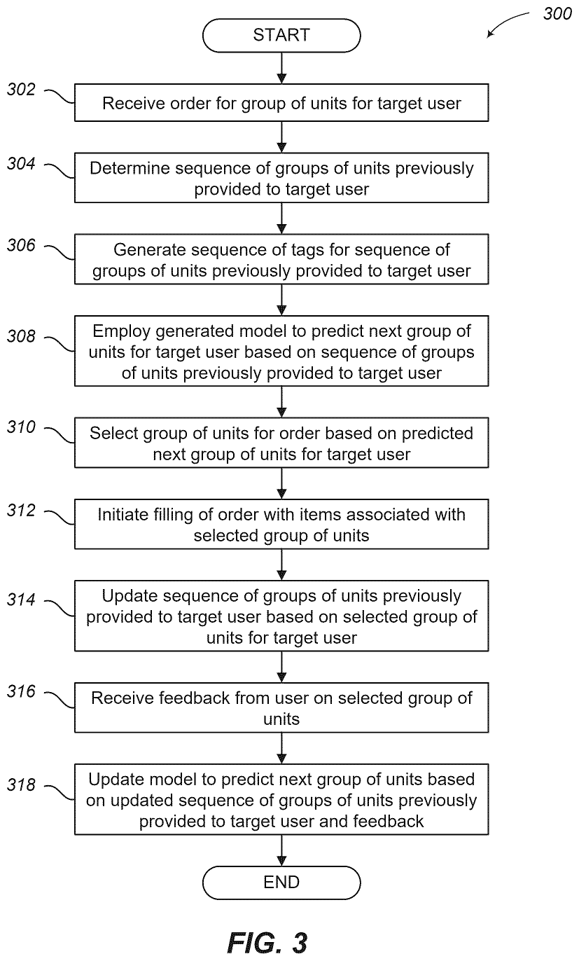

The operation of certain aspects will now be described with respect to FIGS. 3-5. Processes 300, 400, and 500 described in conjunction with FIGS. 3-5, respectively, may be implemented by one or more processors or executed via circuitry on one or more computing devices, such as order-fulfillment system 102 in FIG. 1.

FIG. 3 illustrates a logical flow diagram showing one embodiment of a process 300 for employing of an artificial intelligence model using tags for sequences of units to predict a group of units for a target user and to initiate the filling of an order for the predicted group of units in accordance with embodiments described herein.

Process 300 begins, after a start block, at block 302, where an order for a group of units is received for a target user. In some embodiments, the target user may sign up or register to receive a group of units once a week, every other week, or some other interval within the maximum possible frequency in which units can be provided to users. At the time of selecting units for the target user, process 300 may be performed and the order for that selection of units is received. As one illustrative example, the order may be for a group of recipes, and the corresponding ingredients for those recipes, to be provided to the target user once per week.

Process 300 proceeds, after block 302, to block 304, where a sequence of groups of units previously provided to the target user are determined. In various embodiments, the user database 112 may be accessed to determine the sequence of groups of units previously provided to the target user, which may also be referred to as a history of orders previously provided to the target user. As described herein, the sequence of groups of units may be for a maximum or selected frequency, such as once per week. The target user may or may not have been provided a group of units for each week. For each interval in which the target user was not provided a group of units, the sequence may include a no-unit group.

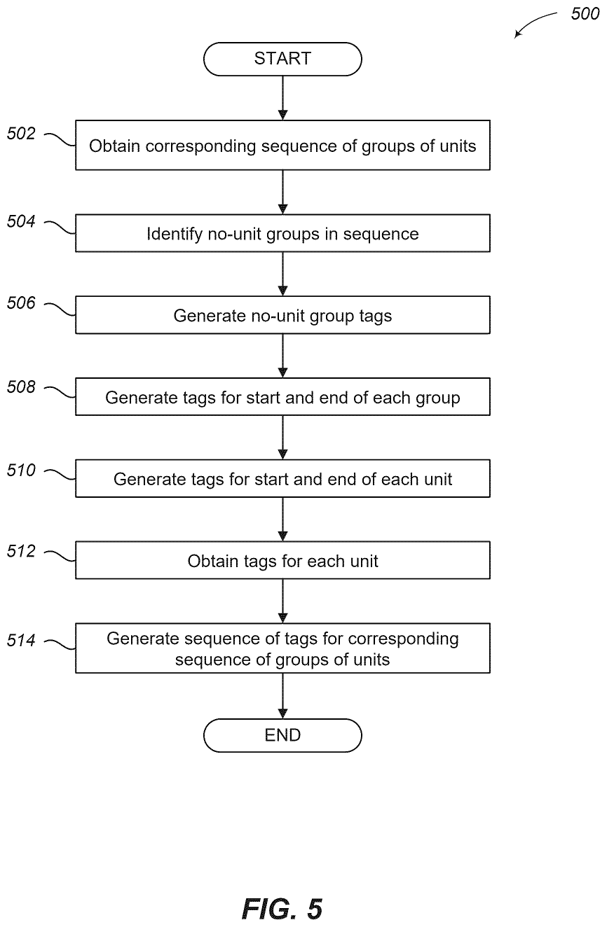

Process 300 continues, after block 304, at block 306, where a sequence of tags is generated for the sequence of groups of units previously provided to the target user. In various embodiments, process 500 in FIG. 5 may be employed to generate the sequence of tags for the target user.

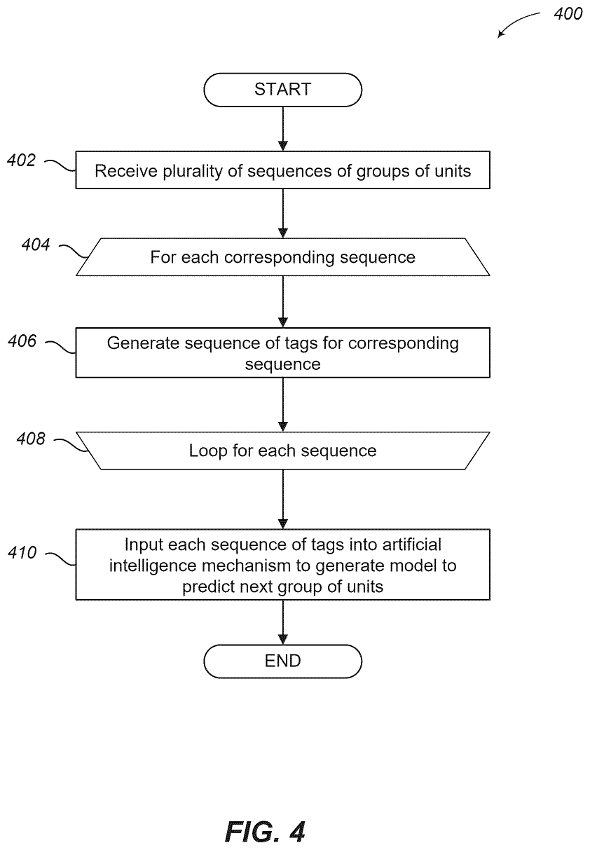

Process 300 proceeds, after block 306, to block 308, where model trained and generated to predict a next group of units (also referred to as recommending future groups of units) for the target user is employed based on the sequence of tags for the sequence of groups of units previous provided to the target user. In various embodiments, process 400 in FIG. 4 may be employed to generate the trained model. The sequence of tags for the sequence of groups of units previous provided to the target user may be input into the model, which outputs one or more predict a next group of units for the target user. For example, the output of the model may be a prediction of 5 separate groups of recipes for the target user, where each group includes a different combination of a plurality recipes.

Process 300 continues, after block 308, at block 310, where a group of units is selected or optimized for the order based on the predicted next groups of units for the target user. Various information regarding the units and items for each unit may be utilized to select the specific group of units from the predicted next group of units. For example, the unit database 116 may be accessed to identify a list of items for each predicted unit, the item-information database 118 may be accessed to obtain additional item information for that list of items, and the item-inventory database 114 may be accessed to obtain inventory management information for that list of items. The system can utilize the predicted groups of units, the additional item information, and the inventory information to select the group of units for the target user. In various other embodiments, the system can also utilize user information (e.g., as obtained from user database 112) to select the group of units for the target user, which allows the system to not only select a group of units that the target user may like, but also to select a group of units that utilizes items already owned by the target user.

In some other embodiments, hard constraints or soft constraints for the target user can be utilized to select the group of units. The soft constraints may define at least one parameter that expresses a tradeoff value associated with a unit or group of units for the target user. For example, the target user may prefer one type of unit (e.g., chicken recipes) over another type of unit (e.g., turkey recipes). The hard constraints may define at least one parameter that cannot be violated by a unit or group of units for the target user. For example, the target user cannot have any units that have a particular item (e.g., the target user is allergic to soy).

Process 300 proceeds, after block 310, to block 312, where filing of the order is initiated with items associated with the selected group of units. In some embodiments, initiating the filing of the order may include sending commands or instructions to another computing system to automatically collect for shipping or automatically ship the items associated with the selected group of units to the target user. In other embodiments, initiating the filing of the order may include sending commands or instructions to another computing system to automatically print or send a copy of the selected group of units to the target user.

Process 300 continues, after block 312, at block 314, where the sequence of groups of units previously provided to the target user is updated based on the selected group of units for the target user. In various embodiments, the selected group of units is added to the sequence of groups of units at a most-recent position within the order of the sequence.

Process 300 proceeds, after block 314, to block 316, where feedback is received from the target user on the selected group of units. In various embodiments, the target user may provide feedback indicating that they liked or did not like a particular unit in the selected group of units, that a particular item was easy or difficult to work with, etc.

Process 300 continues, after block 316, at block 318, where the model to predict a next group of units is updated based on the updated sequence of groups of units previously provided to the target user and the received feedback. In some embodiments, process 400 may be periodically or occasionally performed using the updated sequence of groups of units previously provided to the target user to retrain or update the generated model.

In some embodiments, the model is updated based on a plurality of updated sequence of groups of units previously provided to a plurality of target users. In other embodiments, the model is updated based on feedback from a plurality of target users. In yet other embodiments, the model is updated based on a combination of multiple updated sequence of groups of units previously provided to a plurality of target users along with feedback from a plurality of target users.

After block 318, process 300 terminates or otherwise returns to a calling process to perform other actions.

FIG. 4 illustrates a logical flow diagram showing one embodiment of a process 400 for training an artificial intelligence model using tags for sequences of units to predict a next group of units for a target user in accordance with embodiments described herein.

Process 400 begins, after a start block, at block 402, where a plurality of sequences of groups of units are received. In various embodiments, the plurality of sequences of groups of units may include a plurality of sequences of groups of units previously provided to a plurality of users. As illustrated in FIGS. 2A-2B, each separate sequence may include a plurality of groups of one or more units, where each separate group is sequentially provided (in a particular order) to a user at a maximum frequency. Moreover, in some embodiments, the sequence may include intervals where no groups of units were provided to a user, which may be considered a no-unit group, as illustrated above.

The groups of units in each sequence are ordered sequentially as they were provided to a user. As shown in FIG. 2A, a first group is provided to a user on week 1, a no-unit group is provided to the user on week 2, a second group is provided to a user on week 3, another no-unit group is provided to the user on week 4, and a third group is provided to a user on week 5.

Process 400 proceeds, after block 402, to block 404, where each corresponding sequence is selected from the plurality of obtained sequences of groups of units.

For each corresponding sequence of groups of units, process 400 proceeds, after block 404, to block 406, where a sequence of tags are generated for the corresponding sequence of groups of units, which is described in more detail below in conjunction with FIG. 5.

Process 400 continues, after block 406, at block 408, which loops to block 404 to generate a sequence of tags for each corresponding sequence of groups of units.

Process 400 proceeds, after block 408, to block 410, where each sequence of tags is input into an artificial intelligence mechanism to generate a model to predict a next group of units for a target user based on their previous sequence of groups of units. Each sequence of tags for the plurality of sequences of groups of units may be used as training data to train or generate the model.

After block 410, process 400 terminates or otherwise returns to a calling process to perform other actions.

FIG. 5 illustrates a logical flow diagram showing one embodiment of a process 500 for generating a sequence of tags for a sequence of groups of units in accordance with embodiments described herein. In some embodiments, process 500 may generate a sequence of tags for a sequence of groups of units previously provided to a target user, such as in conjunction with block 306 in FIG. 3. In other embodiments, process 500 may generate a sequence of tags for a corresponding sequence of groups of units that are to be used to train an artificial intelligence model, such as in conjunction with block 406 in FIG. 4.

Process 500 begins, after a start block, at block 502, where a sequence of groups of units that were previously provided to a target user is obtained. Similar to block 402 in FIG. 4, the sequence may include a plurality of groups of one or more units, where each separate group is sequentially provided to the target user at a maximum frequency. And in some embodiments, the sequence may include intervals where no groups of units were provided to the target user, which may be considered a no-unit group, as discussed above.

Process 500 proceeds, after block 502, to block 504 where each no-unit group in the sequence is identified. Each no-unit group is an interval in the corresponding sequence where no group of units were provided to a user.

Process 500 continues, after block 504, at block 506, where no-unit group tags are generated for each identified no-unit group. In various embodiments, a specific no-unit group tag is generated for each identified no-unit group. The no-unit group tag indicates that a group of units should have been provided to a user at the maximum frequency, but not group of units was actually provided to that user.

Process 500 proceeds, after block 506, to block 508, where tags are generated for the start and end of each group in the corresponding sequence. Each corresponding start-group tag indicates the beginning of a corresponding interval at the maximum frequency within the corresponding sequence. And each corresponding end-group tag indicates the end of a corresponding interval at the maximum frequency within the corresponding sequence. The start-group tags and end-group tags are generated for each group of units provided to the user in the corresponding sequence and for each no-unit group in the corresponding sequence. Because each separate group in the corresponding sequence can have a different number of units, or no units at all, the start-group tags and end-group tags tell the artificial intelligence mechanism where each group begins and ends, which allows the artificial intelligence mechanism to train a model that predicts groups of units.

Process 500 continues, after block 508, at block 510, where tags are generated for the start and end of each unit of each group in the corresponding sequence. Each corresponding start-unit tag indicates the beginning of a corresponding unit within a group, and each corresponding end-unit tag indicates the end of the corresponding unit within the group. Because each separate unit in the corresponding sequence can have a different number of items, the start-unit tags and end-group tags tell the artificial intelligence mechanism where each item in a group begins and ends, which allows the artificial intelligence mechanism to train a model that predicts which types of units to include in a group of units.

Process 500 proceeds, after block 510, to block 512, where tags are obtained for each unit of each group in the corresponding sequence. Each tag may identify a particular attribute or aspect of a unit or an item associated with that unit. As an illustrative example where the units are recipes, the unit tags may identify items or ingredients, type of cuisine (e.g., breakfast, lunch, dinner, etc.), nationality of cuisine (e.g., French, Italian, Chinese, etc.), item quantities, number of steps, preparation time, cook time, etc.; and item units may include information describing various aspects of an item, which may include a list of ingredients, dietary information (e.g., number of calories, amount of sugar, amount of fat, etc.), allergens, dietary restrictions (e.g., vegan, dairy free, gluten free, etc.), or other information regarding the item.

In some embodiments, each unit may include metadata identifying the tags associated with that unit. In other embodiments, a database, such as unit database 116 or item-information database 118, may be accessed to obtain the tags associated with each unit of each group in the corresponding sequence. The tags are obtained for each unit of each group in the corresponding sequence.

Process 500 continues, after block 512, at block 514, where a sequence of tags is generated for the corresponding sequence of groups of units for the target user based on the tags generated and obtained in block 506, 508, 510, and 512. The order in which each tag is represented in the sequence of tags is based on the order of each group in the corresponding sequence. In some embodiments, the order of the unit and item tags within a specific group may be numerical, alphabetical, or random, so long as the item tags for a unit in that group are sequentially together with start-item and end-item tags.

After block 514, process 500 terminates or otherwise returns to a calling process to perform other actions.

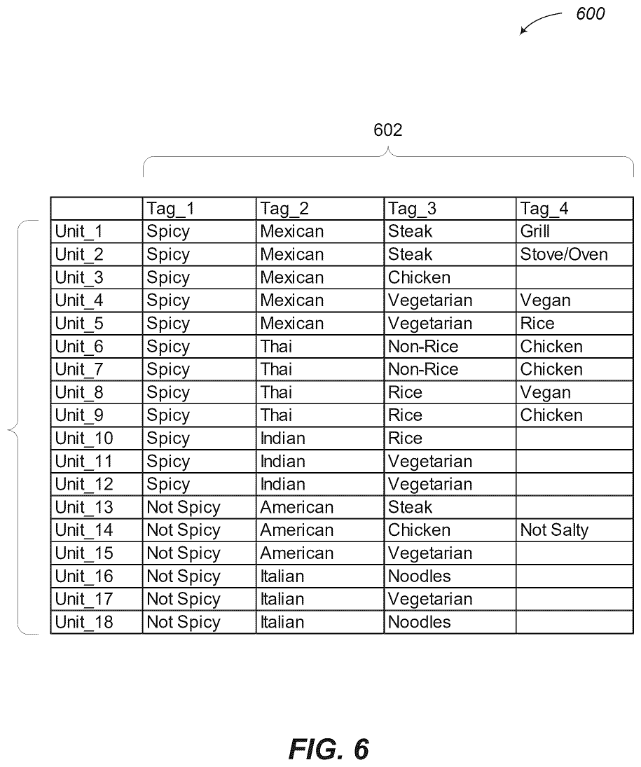

FIG. 6 illustrates a use case example of data structure 600 mapping units and tags in accordance with embodiments described herein. In this illustrative example, data structure 600 is a table that includes units 604 and the mapped tags 602. This data structure 600 may be utilized to obtain the tags associated with the units in a sequence of groups of units, as described herein.

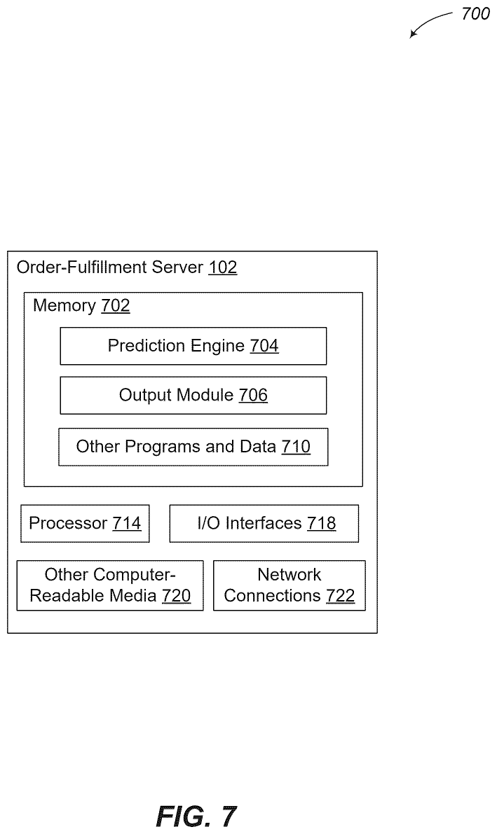

FIG. 7 shows a system diagram that describes various implementations of computing systems for implementing embodiments described herein. System 700 includes an order-fulfillment system 102. System 700 may also include a user database 112, an item-inventory database 114, a unit database 116, an item-information database 118, and user devices 120 similar to what is illustrated in FIG. 1; but those databases, systems, and devices are not illustrated in FIG. 7 for case of discussion.

The order-fulfillment system 102 dynamically generates and maintains an artificial intelligence model based on sequences of tags for sequences of groups of units to predict a next group of units for a target user from a sequence of groups of units previously provided to that target user, as described herein. One or more special-purpose computing systems may be used to implement the order-fulfillment system 102. Accordingly, various embodiments described herein may be implemented in software, hardware, firmware, or in some combination thereof. The order-fulfillment system 102 may include memory 702, processor 714, I/O interfaces 718, other computer-readable media 720, and network connections 722.

Processor 714 includes one or more processors, one or more processing units, programmable logic, circuitry, or one or more other computing components that are configured to perform embodiments described herein or to execute computer instructions to perform embodiments described herein. In some embodiments, a processor system may include a single processor 714 that operates individually to perform actions. In other embodiments, a processor system may include a plurality of processors 714 that operate to collectively perform actions, such that one or more processors 714 may operate to perform some, but not all, of such actions. Reference herein to “a processor system” refers to one or more processors 714 that individually or collectively perform actions. And reference herein to “the processor system” refers to 1) a subset or all of the one or more processors 714 comprised by “a processor system” and 2) any combination of the one or more processors 714 comprised by “a processor system” and one or more other processors 714.

Memory 702 may include one or more various types of non-volatile and/or volatile storage technologies. Examples of memory 702 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 702 may be utilized to store information, including computer-readable instructions that are utilized by processor 714 to perform actions, including embodiments described herein.

Memory 702 may have stored thereon prediction engine 704 and output module 706. The prediction engine 704 is configured to generate and employ an artificial intelligence model that is trained using sequences of tags for a plurality of sequences of groups of units, which is used to predict a next group of units for a target user, as described herein. The output module 704 is configured to select one of the predicted next groups of units and initiate the fulfillment of a user's order, as described herein. Although the prediction engine 704 and output module 706 are illustrated as separate components, embodiments are not so limited. Rather, one or more computing components, modules, or systems may be employed to perform the functionality of the prediction engine 704 and output module 706.

Memory 702 may also store other programs and data 710, may include operating systems or other information. For example, in some embodiments, the data stored by the user database 112, the item-inventory database 114, the unit database 116, or the item-information database 118, or some combination thereof, may be stored in the memory 702 of the order-fulfillment system 102.

In various embodiments, the network connections 722 include transmitters and receivers (not illustrated) to send and receive data as described herein. I/O interfaces 718 may include one or more data input or output interfaces that can be used to receive information from or display information to an administrator. Other computer-readable media 720 may include other types of stationary or removable computer-readable media, such as removable flash drives, external hard drives, or the like.

The following is a summarization of the original claims as filed.

A method may be summarized as comprising: receiving, by a computing system, a plurality of sequences of groups of units; for each corresponding sequence of groups of units of the plurality of sequences of groups of units: generating, by the computing system, tags for a start and an end of each group in the corresponding sequence of groups of units; generating, by the computing system, tags for a start and an end of each unit in the corresponding sequence of groups of units; obtaining, by the computing system, tags for each unit in the corresponding sequence of groups of units; and generating, by the computing system, a sequence of the tags for the corresponding sequence of groups of units. The method may further comprise inputting, by the computing system, each sequence of tags into an artificial intelligence mechanism to generate a model to predict a next group of units; receiving, by the computing system, an order for a group of units for a user; determining, by the computing system, a sequence of groups of units previously provided to the user; employing, by the computing system, the generated model to predict multiple groups of units for the user based on the sequence of groups of units previously provided to the user; selecting, by the computing system, the group of units for the order from the predicted multiple groups of units; and initiating, by the computing system, filling of the order with items associated with the selected group of units for the user.

The method may generate the sequence of tags for the corresponding sequence of groups of units by: identifying, by the computing system, at least one no unit group in the corresponding sequence of groups of units; and generating, by the computing system, a no-unit group tag for each of the at least one no unit group.

The method may generate the sequence of tags for the corresponding sequence of groups of units by: determining, by the computing system, a highest possible frequency of groups of units; and generating, by the computing system, a no-unit group tag for each no unit group within the highest possible frequency for the corresponding sequence of groups of units.

The method may further comprise: updating, by the computing system, the sequence of groups of units previously provided to the user with the selected group of units. In some embodiments, the method may further comprise: updating, by the computing system, the generated model based on the updated sequence of groups of units previously provided to the user.

The method may further comprise: receiving, by the computing system, feedback from the user regarding the selected group of units; and updating, by the computing system, the generated model based on the received feedback.

The method may determine the sequence of groups of units previously provided to the user by: generating, by the computing system, tags for the start and the end of each group of units previously provided to the user; generating, by the computing system, tags for the start and the end of each unit in each group of units previously provided to the user; obtaining, by the computing system, tags for each unit in each group of units previously provided to the user; and generating, by the computing system, the sequence of groups of units previously provided to the user.

A computing system may comprise: at least one memory configured to store computer instructions; and at least one processor system configured to execute the computer instructions to: receive a plurality of sequences of groups of units; for each corresponding sequence of groups of units of the plurality of sequences of groups of units: generate tags for a start and an end of each group in the corresponding sequence of groups of units; generate tags for a start and an end of each unit in the corresponding sequence of groups of units; obtain tags for each unit in the corresponding sequence of groups of units; and generate a sequence of the tags for the corresponding sequence of groups of units; and input each sequence of tags into an artificial intelligence mechanism to generate a model to predict a next group of units.

The at least one processor system may be configured to further execute the computer instructions to: receive an order for a group of units for a user; determine a sequence of groups of units previously provided to the user; employ the generated model to predict multiple groups of units for the user based on the sequence of groups of units previously provided to the user; select the group of units from the predicted multiple groups of units; and initiate filling of the order with items associated with the selected group of units for the user.

The at least one processor system generates the sequence of tags for the corresponding sequence of groups of units by being configured to further execute the computer instructions to: identify at least one no unit group in the corresponding sequence of groups of units; and generate a no-unit group tag for each of the at least one no unit group.

The at least one processor system generates the sequence of tags for the corresponding sequence of groups of units by being configured to further execute the computer instructions to: determine a highest possible frequency of groups of units; and generate a no-unit group tag for each no unit group within the highest possible frequency for the corresponding sequence of groups of units.

The at least one processor system may be configured to further execute the computer instructions to: update the sequence of groups of units previously provided to the user with the selected group of units. In some embodiments, the at least one processor system may be configured to further execute the computer instructions to: update the generated model based on the updated sequence of groups of units previously provided to the user.

The at least one processor system is configured to further execute the computer instructions to: receive feedback from the user regarding the selected group of units; and update the generated model based on the received feedback.

The at least one processor system determines the sequence of groups of units previously provided to the user by being configured to further execute the computer instructions to: generate tags for the start and the end of each group of units previously provided to the user; generate tags for the start and the end of each unit in each group of units previously provided to the user; obtain tags for each unit in each group of units previously provided to the user; and generate the sequence of groups of units previously provided to the user.

A non-transitory computer-readable medium may be summarized as storing computer instructions that, when executed by at least one processor, cause the at least one processor to perform actions, the actions comprising: receiving a plurality of sequences of groups of units; for each corresponding sequence of groups of units of the plurality of sequences of groups of units; generating tags for a start and an end of each group in the corresponding sequence of groups of units; generating tags for a start and an end of each unit in the corresponding sequence of groups of units; obtaining tags for each unit in the corresponding sequence of groups of units; and generating a sequence of tags for the corresponding sequence of groups of units based on the tags for the start and the end of each group, the tags for the start and the end of each unit, and tags for each unit; inputting each sequence of tags into an artificial intelligence mechanism to generate a model to predict a next group of units; employing the generated model to predict a group of units for the user based on a sequence of groups of units previously provided to the user; and initiating filling of an order for the user with items associated with the predicted group of units for the user.

The computer instructions, when executed by the at least one processor, may cause the at least one processor to generate the sequence of tags for the corresponding sequence of groups of units by: identifying, by the computing system, at least one no unit group in the corresponding sequence of groups of units; and generating, by the computing system, a no-unit group tag for each of the at least one no unit group.

The computer instructions, when executed by the at least one processor, may cause the at least one processor to generate the sequence of tags for the corresponding sequence of groups of units by: determining, by the computing system, a highest possible frequency of groups of units; and generating, by the computing system, a no-unit group tag for each no unit group within the highest possible frequency for the corresponding sequence of groups of units.

The computer instructions, when executed by the at least one processor, cause the at least one processor to perform further actions, the further actions comprising: receiving, by the computing system, feedback from the user regarding the selected group of units; and updating, by the computing system, the generated model based on the received feedback.

The computer instructions, when executed by the at least one processor, cause the at least one processor to perform further actions, the further actions comprising: generating, by the computing system, tags for the start and the end of each group of units previously provided to the user; generating, by the computing system, tags for the start and the end of each unit in each group of units previously provided to the user; obtaining, by the computing system, tags for each unit in each group of units previously provided to the user; and generating, by the computing system, the sequence of groups of units previously provided to the user.

The various embodiments described above can be combined to provide further embodiments. These and other changes can be made to the embodiments in light of the above-detailed description. All of the U.S. patents, U.S. patent application publications, U.S. patent applications, foreign patents, foreign patent applications and non-patent publications listed in the Application Data Sheet are incorporated by reference, in their entirety. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
receiving, by a computing system, a plurality of sequences of groups of units;
for each corresponding sequence of groups of units of the plurality of sequences of groups of units:
generating, by the computing system, tags for a start and an end of each group in the corresponding sequence of groups of units;
generating, by the computing system, tags for a start and an end of each unit in the corresponding sequence of groups of units;
obtaining, by the computing system, tags for each unit in the corresponding sequence of groups of units; and
generating, by the computing system, a sequence of the tags for the corresponding sequence of groups of units;
inputting, by the computing system, each sequence of tags into an artificial intelligence mechanism to generate a model to predict a next group of units;
receiving, by the computing system, an order for a group of units for a user;
determining, by the computing system, a sequence of groups of units previously provided to the user;
employing, by the computing system, the generated model to predict multiple groups of units for the user based on the sequence of groups of units previously provided to the user;
selecting, by the computing system, the group of units for the order from the predicted multiple groups of units; and
initiating, by the computing system, filling of the order with items associated with the selected group of units for the user.

2. The method of claim 1, wherein generating the sequence of tags for the corresponding sequence of groups of units, includes:
identifying, by the computing system, at least one no unit group in the corresponding sequence of groups of units; and
generating, by the computing system, a no-unit group tag for each of the at least one no unit group.

3. The method of claim 1, wherein generating the sequence of tags for the corresponding sequence of groups of units, includes:
determining, by the computing system, a highest possible frequency of groups of units; and
generating, by the computing system, a no-unit group tag for each no unit group within the highest possible frequency for the corresponding sequence of groups of units.

4. The method of claim 1, further comprising:
updating, by the computing system, the sequence of groups of units previously provided to the user with the selected group of units.

5. The method of claim 4, further comprising:
updating, by the computing system, the generated model based on the updated sequence of groups of units previously provided to the user.

6. The method of claim 1, further comprising:
receiving, by the computing system, feedback from the user regarding the selected group of units; and
updating, by the computing system, the generated model based on the received feedback.

7. The method of claim 1, wherein determining the sequence of groups of units previously provided to the user, includes:
generating, by the computing system, tags for the start and the end of each group of units previously provided to the user;
generating, by the computing system, tags for the start and the end of each unit in each group of units previously provided to the user;
obtaining, by the computing system, tags for each unit in each group of units previously provided to the user; and
generating, by the computing system, the sequence of groups of units previously provided to the user.

8. A computing system, comprising:
at least one memory configured to store computer instructions;
at least one processor system configured to execute the computer instructions to:
receive a plurality of sequences of groups of units;
for each corresponding sequence of groups of units of the plurality of sequences of groups of units:
generate tags for a start and an end of each group in the corresponding sequence of groups of units;
generate tags for a start and an end of each unit in the corresponding sequence of groups of units;
obtain tags for each unit in the corresponding sequence of groups of units; and
generate a sequence of the tags for the corresponding sequence of groups of units; and
input each sequence of tags into an artificial intelligence mechanism to generate a model to predict a next group of units.

9. The computing system of claim 8, wherein the at least one processor system is configured to further execute the computer instructions to:
receive an order for a group of units for a user;
determine a sequence of groups of units previously provided to the user;
employ the generated model to predict multiple groups of units for the user based on the sequence of groups of units previously provided to the user;
select the group of units from the predicted multiple groups of units; and
initiate filling of the order with items associated with the selected group of units for the user.

10. The computing system of claim 8, wherein the at least one processor system generates the sequence of tags for the corresponding sequence of groups of units by being configured to further execute the computer instructions to:
identify at least one no unit group in the corresponding sequence of groups of units; and
generate a no-unit group tag for each of the at least one no unit group.

11. The computing system of claim 8, wherein the at least one processor system generates the sequence of tags for the corresponding sequence of groups of units by being configured to further execute the computer instructions to:
determine a highest possible frequency of groups of units; and
generate a no-unit group tag for each no unit group within the highest possible frequency for the corresponding sequence of groups of units.

12. The computing system of claim 8, wherein the at least one processor system is configured to further execute the computer instructions to:
update the sequence of groups of units previously provided to the user with the selected group of units.

13. The computing system of claim 12, wherein the at least one processor system is configured to further execute the computer instructions to:
update the generated model based on the updated sequence of groups of units previously provided to the user.

14. The computing system of claim 8, wherein the at least one processor system is configured to further execute the computer instructions to:
receive feedback from the user regarding the selected group of units; and
update the generated model based on the received feedback.

15. The computing system of claim 8, wherein the at least one processor system determines the sequence of groups of units previously provided to the user by being configured to further execute the computer instructions to:
generate tags for the start and the end of each group of units previously provided to the user;
generate tags for the start and the end of each unit in each group of units previously provided to the user;
obtain tags for each unit in each group of units previously provided to the user; and
generate the sequence of groups of units previously provided to the user.

16. A non-transitory computer-readable medium storing computer instructions that, when executed by at least one processor, cause the at least one processor to perform actions, the actions comprising:
receiving a plurality of sequences of groups of units;
for each corresponding sequence of groups of units of the plurality of sequences of groups of units:
generating tags for a start and an end of each group in the corresponding sequence of groups of units;
generating tags for a start and an end of each unit in the corresponding sequence of groups of units;
obtaining tags for each unit in the corresponding sequence of groups of units; and
generating a sequence of tags for the corresponding sequence of groups of units based on the tags for the start and the end of each group, the tags for the start and the end of each unit, and tags for each unit;
inputting each sequence of tags into an artificial intelligence mechanism to generate a model to predict a next group of units;
employing the generated model to predict a group of units for the user based on a sequence of groups of units previously provided to the user; and
initiating filling of an order for the user with items associated with the predicted group of units for the user.

17. The non-transitory computer-readable medium of claim 16, wherein generating the sequence of tags for the corresponding sequence of groups of units, includes:
identifying, by the computing system, at least one no unit group in the corresponding sequence of groups of units; and
generating, by the computing system, a no-unit group tag for each of the at least one no unit group.

18. The non-transitory computer-readable medium of claim 16, wherein generating the sequence of tags for the corresponding sequence of groups of units, includes:
determining, by the computing system, a highest possible frequency of groups of units; and
generating, by the computing system, a no-unit group tag for each no unit group within the highest possible frequency for the corresponding sequence of groups of units.

19. The non-transitory computer-readable medium of claim 16, wherein the computer instructions, when executed by the at least one processor, cause the at least one processor to perform further actions, the further actions comprising:
receiving, by the computing system, feedback from the user regarding the selected group of units; and
updating, by the computing system, the generated model based on the received feedback.

20. The non-transitory computer-readable medium of claim 16, wherein the computer instructions, when executed by the at least one processor, cause the at least one processor to perform further actions, the further actions comprising:
generating, by the computing system, tags for the start and the end of each group of units previously provided to the user;
generating, by the computing system, tags for the start and the end of each unit in each group of units previously provided to the user;
obtaining, by the computing system, tags for each unit in each group of units previously provided to the user; and
generating, by the computing system, the sequence of groups of units previously provided to the user.
